(19) United States
(12) Patent Application Publication
(10) Pub. No.: US 2026/0217110 A1
(43) Pub. Date: Jul. 30, 2026

(54) VEHICLE-MOUNTED REMOTE CONTROLLER AND METHOD, SYSTEM, MEDIUM OF RECOGNIZING THE POSITION AND POSTURE OF THE VEHICLE-MOUNTED REMOTE CONTROLLER

(71) Applicant: GOERTEK TECHNOLOGY CO., LTD, Qingdao, Shandong (CN)

(72) Inventor: Bei YANG, Qingdao, Shandong (CN)

(21) Appl. No.: 19/147,483

(22) PCT Filed: Dec. 3, 2024
(86) PCT No.: PCT/CN2024/136432

§ 371 Date: Jul. 11, 2025

(30) Foreign Application Priority Data
Dec. 5, 2023 (CN) 202311660681.X

(51) Int. Cl. B60K 35/10; G06F 3/0346; G08C 25/00

(52) U.S. Cl. CPC B60K 35/10; G06F 3/0346; G08C 25/00

(57) ABSTRACT

Disclosed are a vehicle-mounted remote controller and method, system and medium of recognizing a position and posture of a vehicle-mounted remote controller, pertaining to the field of vehicle interaction technology. The method of recognizing the position and posture of the vehicle-mounted remote controller includes: acquiring an initial position and posture of the vehicle-mounted remote controller; dynamically acquiring first motion data collected by the first inertial sensing module, and dynamically acquiring second motion data collected by the second inertial sensing module; correcting the second motion data based on the first motion data to obtain current motion data of the vehicle-mounted remote controller; and determining a current position and posture of the vehicle-mounted remote controller according to the initial position and posture and the current motion data. Therefore, the technical problem of low accuracy of position and posture recognition of vehicle-mounted remote controllers in the related art are solved.

This application claims the priority to the Chinese patent application No. 202311660681.X, entitled “VEHICLE-MOUNTED REMOTE CONTROLLER AND METHOD, SYSTEM, MEDIUM OF RECOGNIZING THE POSITION AND POSTURE OF THE VEHICLE-MOUNTED REMOTE CONTROLLER”, filed with China National Intellectual Property Administration on Dec. 5, 2023, all contents of which are incorporated herein by reference.

### TECHNICAL FIELD

The present disclosure relates to the field of vehicle interaction technology, and specifically, to a vehicle-mounted remote controller and method, system, medium of recognizing the position and posture of the vehicle-mounted remote controller.

### DESCRIPTION OF RELATED ART

With the increasing maturity of high-precision positioning technologies such as UWB (Ultra-Wide Band) and Bluetooth AOA (Angle of Arrival), interaction with vehicle devices using vehicle-mounted remote controllers has become an important area. The vehicle-mounted remote controller's ability to “point and shoot” has improved the convenience of user's interaction with vehicle devices. To realize interaction between the vehicle-mounted remote controller and the vehicle devices, it is necessary to accurately acquire the position and posture of the vehicle-mounted remote controller in the vehicle, and then accurately recognize the target device that the remote controller faces according to the position and posture of the vehicle-mounted remote controller in the vehicle to achieve interaction.

Conventional remote controllers or other handheld devices can estimate the position and posture of an object by providing inertial navigation sensors. However, in a vehicle environment, the movement of the vehicle will generate interference signals, which in turn affects the posture recognition of the object, resulting in low position and posture recognition accuracy of the vehicle-mounted remote controller.

The above contents are only configured to assist in understanding the technical solution of the present disclosure and do not constitute an admission that the above contents are prior art.

### SUMMARY

The main purpose of the present disclosure is to provide a vehicle-mounted remote controller and method, system, medium of recognizing the position and posture of the vehicle-mounted remote controller, aiming to solve the technical problem of low accuracy in recognizing the position and posture of the vehicle-mounted remote controller.

To achieve the above-mentioned purpose, the present disclosure provides a method of recognizing a position and posture of a vehicle-mounted remote controller, applied to a vehicle-mounted remote controller position and posture recognition system including a vehicle having a first inertial sensing module disposed therein and a vehicle-mounted remote controller having a second inertial sensing module disposed therein, including:
acquiring an initial position and posture of the vehicle-mounted remote controller;
dynamically acquiring first motion data collected by the first inertial sensing module, and dynamically acquiring second motion data collected by the second inertial sensing module;
correcting the second motion data based on the first motion data to obtain current motion data of the vehicle-mounted remote controller; and
determining a current position and posture of the vehicle-mounted remote controller according to the initial position and posture and the current motion data.

Optionally, the vehicle is provided with at least one storage slot for fixing the vehicle-mounted remote controller and keeping the position and posture thereof unchanged in the vehicle, and the acquiring the initial position and posture of the vehicle-mounted remote controller includes:
determining a target storage slot of the vehicle-mounted remote controller where it was last placed before being taken out, based on a detecting sensor provided in the storage slot; and
recognizing a preset fixed position and posture of the vehicle-mounted remote controller when it is in the target storage slot, and determining the recognized preset fixed position and posture as the initial position and posture.

Optionally, the correcting the second motion data based on the first motion data to obtain current motion data of the vehicle-mounted remote controller includes:
determining relative motion data of the vehicle-mounted remote controller relative to the vehicle according to a data difference between the first motion data and the second motion data, and determining the relative motion data as the current motion data.

Optionally, the vehicle is provided with at least one storage slot for fixing the vehicle-mounted remote controller and keeping the position and posture thereof unchanged in the vehicle, and after the determining the current position and posture of the vehicle-mounted remote controller, the method further includes:
determining whether the vehicle-mounted remote controller is in the storage slot of the vehicle; and
if it is, entering the vehicle-mounted remote controller into a sleep state, and stopping the dynamically acquiring the second motion data collected by the second inertial sensing module.

Optionally, the determining whether the vehicle-mounted remote controller is in the storage slot of the vehicle includes:
determining whether the current position and posture matches a preset fixed position and posture, and whether a duration for which the current position and posture matches the fixed position and posture is greater than a preset duration, wherein the fixed position and posture is a position and posture of the vehicle-mounted remote controller when it is in the storage slot of the vehicle; and
if it matches, determining that the vehicle-mounted remote controller is in the storage slot of the vehicle.

Optionally, at least one detecting sensor for detecting whether the vehicle-mounted remote controller is placed in the storage slot is provided in the storage slot, and the determining whether the vehicle-mounted remote controller is in the storage slot of the vehicle includes:
in response to detecting that the detected signal collected by the detecting sensor matches a preset signal, determining that the vehicle-mounted remote controller is in the storage slot of the vehicle.

Optionally, at least one detecting sensor for detecting whether the vehicle-mounted remote controller is placed in the storage slot is provided in the storage slot, and wherein after the entering the vehicle-mounted remote controller into the sleep state, the method further includes:
dynamically acquiring the detected signal collected by the detecting sensor; and
in response to detecting that the detected signal does not match the preset signal, awakening the vehicle-mounted remote controller from the sleep state, and resuming the dynamically acquiring the second motion data collected by the second inertial sensing module.

The present disclosure further provides a vehicle-mounted remote controller position and posture recognition system including a vehicle, a vehicle-mounted remote controller and a control device communicatively connected to one another, wherein the vehicle-mounted remote controller position and posture recognition system includes:
the vehicle having a first inertial sensing module disposed therein;
the vehicle-mounted remote controller having a second inertial sensing module disposed therein; and
the control device configured to: acquire an initial position and posture of the vehicle-mounted remote controller; dynamically acquire first motion data collected by the first inertial sensing module, and dynamically acquire second motion data collected by the second inertial sensing module; correct the second motion data based on the first motion data to obtain current motion data of the vehicle-mounted remote controller; and determine a current position and posture of the vehicle-mounted remote controller according to the initial position and posture and the current motion data.

The present disclosure further provides a vehicle-mounted remote controller including a memory, a processor, and a vehicle-mounted remote controller position and posture recognition program stored in the memory and executable by the processor, wherein the vehicle-mounted remote controller position and posture recognition program is configured to implement steps of the method of recognizing the position and posture of a vehicle-mounted remote controller as described above.

The present disclosure further provides a storage medium, wherein the storage medium is a computer-readable storage medium, and a vehicle-mounted remote controller position and posture recognition program is stored on the storage medium, wherein the vehicle-mounted remote controller position and posture recognition program is configured to implement, when executed by a processor, steps of the method of recognizing the position and posture of a vehicle-mounted remote controller as described above.

The present disclosure discloses a method of recognizing the position and posture of a vehicle-mounted remote controller. The method acquires the initial position and posture of the vehicle-mounted remote controller, and dynamically acquires first motion data of the vehicle collected by a first inertial sensing module disposed on the vehicle, and second motion data of the vehicle-mounted remote controller collected by a second inertial sensing module disposed on the vehicle-mounted remote controller; then, based on the first motion data of the vehicle, the second motion data of the vehicle-mounted remote controller is corrected to eliminate the data error caused by the motion of the vehicle in a vehicle-mounted scenario, and to obtain accurate current motion data of the vehicle-mounted remote controller; then, based on the initial position and posture and the accurate current motion data, the current position and posture of the vehicle-mounted remote controller is accurately recognized, thereby improving the accuracy of the position and posture recognition of the vehicle-mounted remote controller in a vehicle-mounted scenario.

### BRIEF DESCRIPTION OF DRAWINGS

FIG. 1 is a schematic diagram of the structure of a vehicle-mounted remote controller in a hardware operating environment according to an embodiment of the present disclosure;

FIG. 2 is a schematic diagram of a flow chart of a method of recognizing the position and posture of a vehicle-mounted remote controller according to an embodiment of the present disclosure;

FIG. 3 is a schematic diagram of the structure of the storage slot according to an embodiment of the present disclosure;

FIG. 4 is a schematic block diagram of the vehicle-mounted remote controller position and posture recognition system according to an embodiment of the present disclosure;

FIG. 5 is a schematic diagram of a scenario of a method of recognizing the position and posture of a vehicle-mounted remote controller according to an embodiment of the present disclosure.

The realization of the purpose, functional features and advantages of this application will be further explained in conjunction with embodiments and with reference to the accompanying drawings.

### DETAILED DESCRIPTIONS

It will be understood that the specific embodiments described herein are only configured to explain the present disclosure and are not configured to limit the present disclosure.

In addition, the descriptions of “first”, “second”, etc. in this application are only for descriptive purposes and cannot be understood as indicating or implying their relative importance or implicitly indicating the number of technical features indicated. Therefore, the features defined as “first” and “second” may explicitly or implicitly include at least one of the features. In addition, “and/or” in the full text includes three solutions. Taking A and/or B as an example, it includes technical solution A, technical solution B, and technical solution that satisfies both A and B; in addition, the technical solutions between the various embodiments can be combined with each other, but it must be based on the ability of ordinary technicians in this field to implement. When the combination of technical solutions is contradictory or cannot be implemented, it will be understood that such combination of technical solutions does not exist and is not within the scope of protection required by this application.

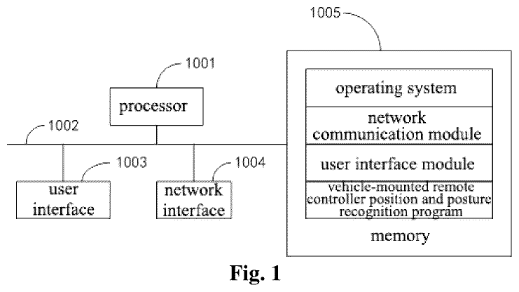

Referring to FIG. 1, which is a schematic diagram of the structure of a vehicle-mounted remote controller in the hardware operating environment according to an embodiment of the present disclosure.

As shown in FIG. 1, the vehicle-mounted remote controller may include: a processor 1001, such as a central processing unit (CPU), a communication bus 1002, a user interface 1003, a network interface 1004, and a memory 1005. The communication bus 1002 is configured for the connection and communication between these components. The user interface 1003 may include a display screen (Display), an input unit such as a keyboard, and the optional user interface 1003 may also include a standard wired interface and a wireless interface. The network interface 1004 may optionally include a standard wired interface and a wireless interface (such as a wireless fidelity (Wi-Fi) interface). The memory 1005 may be a high-speed random-access memory (RAM) memory, or a non-volatile memory (NVM), such as a disk memory. The memory 1005 may also be a storage system independent of the processor 1001.

Those skilled in the art will appreciate that the vehicle-mounted remote controller is not limited to the structure shown in FIG. 1, and may include more or fewer components than that are shown in the figure, or combine certain components, or arrange the components differently.

As shown in FIG. 1, the memory 1005 as a storage medium may include an operation system, a data storage module, a network communication module, a user interface module, and a vehicle-mounted remote controller position and posture recognition program.

In the vehicle-mounted remote controller shown in FIG. 1, the network interface 1004 may be provided for data communication with other devices; the user interface 1003 may be provided for data interaction with the user; the processor 1001 and the memory 1005 in the vehicle-mounted remote controller of the present disclosure can be disposed in the vehicle-mounted remote controller, and the vehicle-mounted remote controller execute the vehicle-mounted remote controller position and posture recognition program stored in the memory 1005 through the processor 1001, and performs the following operations:
acquiring an initial position and posture of the vehicle-mounted remote controller;
dynamically acquiring first motion data collected by the first inertial sensing module, and dynamically acquiring the second motion data collected by the second inertial sensing module;
correcting the second motion data based on the first motion data to obtain the current motion data of the vehicle-mounted remote controller; and
determining the current position and posture of the vehicle-mounted remote controller according to the initial position and posture and the current motion data.

Furthermore, the vehicle is provided with at least one storage slot for fixing the vehicle-mounted remote controller and keeping the position and posture thereof unchanged in the vehicle, and the acquiring the initial position and posture of the vehicle-mounted remote controller includes:
determining a target storage slot of the vehicle-mounted remote controller where it was last placed before being taken out, based on a detecting sensor provided in the storage slot; and
recognizing a preset fixed position and posture of the vehicle-mounted remote controller when it is in the target storage slot, and determining the recognized preset fixed position and posture as the initial position and posture.

Furthermore, the correcting the second motion data based on the first motion data to obtain the current motion data of the vehicle-mounted remote controller includes:
determining relative motion data of the vehicle-mounted remote controller relative to the vehicle according to a data difference between the first motion data and the second motion data, and determining the relative motion data as the current motion data.

Furthermore, the processor 1001 may execute the vehicle-mounted remote controller position and posture recognition program stored in the memory 1005, and performs the following operations:
the vehicle is provided with at least one storage slot for fixing the vehicle-mounted remote controller and keeping the position and posture thereof unchanged in the vehicle, and after the determining the current position and posture of the vehicle-mounted remote controller, the method further includes:
determining whether the vehicle-mounted remote controller is in the storage slot of the vehicle; and
if it is, entering the vehicle-mounted remote controller into a sleep state, and stopping the dynamically acquiring the second motion data collected by the second inertial sensing module.

Furthermore, the determining whether the vehicle-mounted remote controller is in the storage slot of the vehicle includes:
determining whether the current position and posture matches a preset fixed position and posture, and whether a duration for which the current position and posture matches the fixed position and posture is greater than a preset duration, wherein the fixed position and posture is a position and posture of the vehicle-mounted remote controller when it is in the storage slot of the vehicle; and
if it is, determining that the vehicle-mounted remote controller is in the storage slot of the vehicle.

Furthermore, at least one detecting sensor for detecting whether the vehicle-mounted remote controller is placed in the storage slot is provided in the storage slot, and the determining whether the vehicle-mounted remote controller is in the storage slot of the vehicle includes:
in response to detecting that the detected signal collected by the detecting sensor matches a preset signal, determining that the vehicle-mounted remote controller is in the storage slot of the vehicle.

Furthermore, the processor 1001 may execute the vehicle-mounted remote controller position and posture recognition program stored in the memory 1005, and performs the following operations:
at least one detecting sensor for detecting whether the vehicle-mounted remote controller is placed in the storage slot is provided in the storage slot, and wherein after the entering the vehicle-mounted remote controller into the sleep state, the method further includes:
dynamically acquiring detected signal collected by the detecting sensor; and
in response to detecting that the detected signal does not match a preset signal, awakening the vehicle-mounted remote controller from the sleep state, and resuming the dynamically acquiring the second motion data collected by the second inertial sensing module.

Based on the above configurations, various embodiments of a method of recognizing the position and posture of a vehicle-mounted remote controller are proposed.

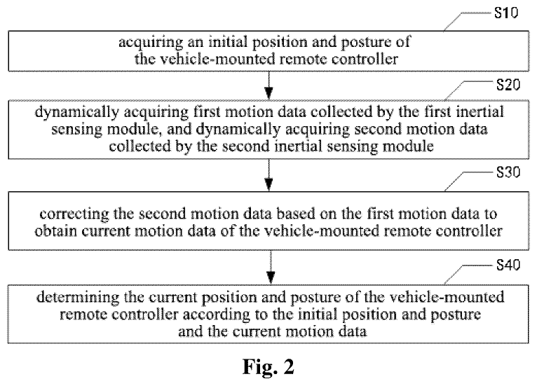

Referring to FIG. 2, which is a flow chart of a first embodiment of a method of recognizing the position and posture of a vehicle-mounted remote controller according to the present disclosure.

In this embodiment, the execution subject of the method of recognizing the position and posture of a vehicle-mounted remote controller may be a vehicle-mounted remote controller, which is a handheld device capable of interacting with the vehicle device, which can be a separate newly added physical device, or a device capable of interacting with the vehicle device by adding corresponding software and hardware modules to existing devices (for example, car keys, mobile phones, etc.). The execution subject of the method can also be a control device, which can be a local device, such as the central control system of the vehicle, the electronic control unit (ECU), etc., or a mobile terminal such as a mobile phone or a notebook, or a functional module installed on the vehicle or the vehicle-mounted remote controller, which is configured to acquire the initial position and posture and motion data of the vehicle-mounted remote controller to accurately recognize the current position and posture of the vehicle-mounted remote controller; the control device can also be a remote device, which is not limited in this embodiment. For the sake of convenience, the description of the execution subject performing each embodiment is omitted. In this embodiment, a first inertial sensing module is provided in the vehicle, and a second inertial sensing module is provided in the vehicle-mounted remote controller. The method of recognizing the position and posture of a vehicle-mounted remote controller includes:
Step S10, acquiring an initial position and posture of the vehicle-mounted remote controller;

The initial position and posture of the vehicle-mounted remote controller may be acquired while it is in use, wherein the initial position and posture may be the position and posture before the vehicle-mounted remote controller starts to move (for example, is picked up), including the initial position and initial posture.

It will be understood that the positions and postures mentioned in this embodiment, including the initial position and posture, current position and posture, real-time position and posture, etc., are all the positions and postures of the vehicle-mounted remote controller in the vehicle, that is, the positions and postures of the vehicle-mounted remote controller in the vehicle coordinate system of the vehicle, wherein the vehicle coordinate system can be established with the vehicle cabin as a reference, and then the position and posture of the vehicle-mounted remote controller in the vehicle coordinate system can be determined.

The vehicle devices are various functional devices installed on the vehicle, such as air conditioner, audio and video entertainment systems, seats, trunk, sunroof, windows, etc., the embodiments are not limited to it; a vehicle can be provided with multiple vehicle devices, and the user can send interaction instructions to various interactive devices on the vehicle at any position in the vehicle cabin through the vehicle-mounted remote controller, so that the human-machine capable of interacting with the various interactive devices in the vehicle is no longer limited to the user's position, and human-machine capable of interacting with the vehicle's interactive devices can be achieved at any position in the vehicle cabin, especially improving the convenience of interaction in multi-person riding scenarios, can meet the interaction needs of passengers in various positions of the vehicle, and can enhance the user experience.

In an alternative embodiment, the vehicle is provided with at least one storage slot for fixing the vehicle-mounted remote controller and keeping the position and posture thereof unchanged in the vehicle, and step S10, the acquiring the initial position and posture of the vehicle-mounted remote controller includes:
Step S11, determining a target storage slot of the vehicle-mounted remote controller where it was last placed before being taken out, based on a detecting sensor provided in the storage slot.

In order to improve the accuracy of initial position and posture recognition of the vehicle-mounted remote controller and reduce the power consumption of real-time position and posture calculation at the same time, at least one storage slot is set in the vehicle, and the storage slot is configured to fix the vehicle-mounted remote controller, so that when the vehicle-mounted remote controller is in the storage slot, the position and posture thereof is remained unchanged in the vehicle; and each storage slot can also be provided with at least one detecting sensor to detect whether the vehicle-mounted remote controller is placed in the storage slot, and which storage slot it is placed in specifically; and then based on the detected signals collected by the detecting sensors disposed in each storage slot, the last storage slot (hereinafter referred to as the target storage slot for distinction) where the vehicle-mounted remote controller was located before being taken out (picked up) can be determined.

Step S12, recognizing a preset fixed position and posture of the vehicle-mounted remote controller when it is in the target storage slot, and determining the recognized preset fixed position and posture as the initial position and posture.

The storage slot can be a space with a fixed shape and size preset in the vehicle cabin, and cannot be changed after leaving the factory; the storage slot not only used for the purpose of storage, but more importantly, also setting the initial position and posture of the vehicle-mounted remote controller by placing it in the storage slot itself in the vehicle space, that is, when the vehicle-mounted remote controller is in the storage slot, the position and posture thereof in the vehicle coordinate system of the vehicle are known; then the preset position and posture of the vehicle-mounted remote controller when it is in the target storage slot are determined (hereinafter referred to as the fixed position for distinction), and the fixed position and posture are determined as the initial position and posture to achieve accurate recognition of the initial position and posture of the vehicle-mounted remote controller.

Optionally, the storage location may have obvious poka-yoke measures to ensure that the user can only put the vehicle-mounted remote controller in a fixed direction.

Optionally, when there are multiple storage slots in the vehicle, each storage slot corresponds to one fixed position and posture; by determining the last target storage slot where the vehicle-mounted remote controller was located before being taken out, the position and posture of the vehicle-mounted remote controller in the storage slot can be determined as the initial position and posture.

Optionally, when there is only one storage slot in the vehicle, the fixed position and posture of the storage slot can be set as the default position and posture of the vehicle-mounted remote controller, so that the default position and posture are determined as the initial position and posture.

Optionally, since the position and posture of the vehicle-mounted remote controller when it is in the storage slot is known and fixed, when the vehicle-mounted remote controller is in the storage slot, the motion data of the second inertial sensing module can be stopped, and the vehicle-mounted remote controller can be put into enter a sleep state to reduce power consumption. The conventional handheld device position and posture recognition method needs to be calculated and stored in real time, and has the problem of large power consumption and calculation amount, and if in order to reduce power consumption, the handheld device can be put into a sleep state when the position and posture changes are small; but in order to ensure the accuracy of position and posture recognition, it is necessary to ensure that the handheld device can be awakened in time, and if there is a delay in the awakening of the handheld device and the user moves the handheld device, it may cause the initial position and posture stored before entering the sleep state to become invalid. Compared to this, the present embodiment, by providing the storage slot, can accurately and timely determine the initial position and posture of the vehicle-mounted remote controller when it is taken out, and when the vehicle-mounted remote controller is placed in the storage slot, it can enter a sleep state, ensuring the accuracy of the initial position and posture while reducing power consumption and calculation amount.

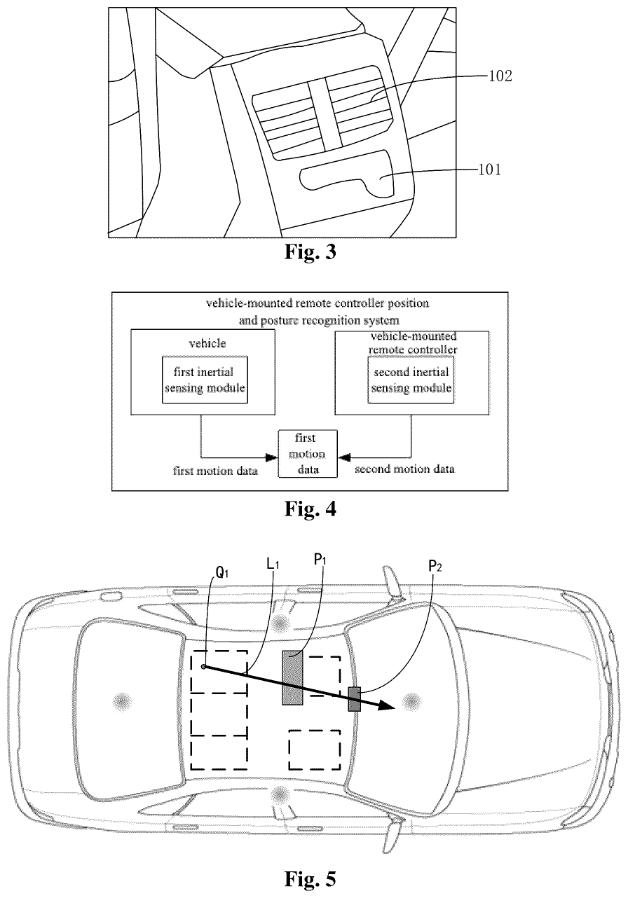

In an embodiment, referring to FIG. 3, the storage slot 101 is a preset groove in the vehicle cabin, which can be disposed below the air-conditioner outlet 102 in the rear row of the vehicle. Its structural shape is like a wedge that is larger at the top and smaller at the bottom, so that the vehicle-mounted remote controller cannot be easily moved after being placed in the storage slot 101, that is, the vehicle-mounted remote controller placed in the storage slot 101 cannot be displaced in normal driving environments such as ordinary bumps, turns, ups and downs, etc.; thereby ensuring that when the vehicle-mounted remote controller is in the storage slot 101, the position and posture thereof is a preset position and posture (hereinafter referred to as a preset fixed position and posture for distinction).

The detecting sensor can be a pressure sensor, a light sensor, etc., and can also provide multiple functions. For example, it can realize the charging function of the vehicle-mounted remote controller, which can be charging or wireless charging, etc. On the one hand, it can accurately determine the initial position and posture of the vehicle-mounted remote controller, and on the other hand, it can also charge the vehicle-mounted remote controller in time.

In this embodiment, since only the movement of the vehicle-mounted remote controller can be known through the inertial sensing module, it is difficult to determine the real-time position and posture of the vehicle-mounted remote controller in the vehicle if the vehicle-mounted remote controller is not provided with a positioning device such as UWB and the initial position and posture of the vehicle-mounted remote controller cannot be known; therefore, the acquisition of the initial position and posture is important to the position and posture recognition of the vehicle-mounted remote controller in the vehicle. Moreover, in this embodiment the vehicle is provided with at least one storage slot for fixing and keeping the position thereof unchanged in the vehicle, and based on the detecting sensors provided in each storage slot, the target storage slot where it was last placed before being taken out is determined; further, the preset fixed position and posture of the vehicle-mounted remote controller when it is in the target storage slot is directly determined as the initial position and posture to realize accurate recognition of the initial position and posture; and accurate real-time determination of the position an posture can also be realized when the vehicle-mounted remote controller is not installed with a positioning device such as UWB, thereby reducing the embodiment cost.

Step S20, dynamically acquiring first motion data collected by the first inertial sensing module, and dynamically acquiring the second motion data collected by the second inertial sensing module;

The motion data of the vehicle (hereinafter referred to as the first motion data for distinction) collected by the inertial sensing module (hereinafter referred to as the first inertial sensing module for distinction) disposed on the vehicle, and the motion data of the vehicle-mounted remote controller (hereinafter referred to as the second motion data for distinction) collected by the inertial sensing module (hereinafter referred to as the second inertial sensing module for distinction) disposed on the vehicle-mounted remote controller may be dynamically acquired, while the vehicle-mounted remote controller is in use.

The motion data may include the three-axis acceleration, three-axis angular velocity, etc. measured by the inertial sensing module on its measurement axis at each moment, and may also include the position and posture of the device (e.g., a vehicle-mounted remote controller, or a vehicle, etc.) on which the inertial sensing module is installed at each moment.

The inertial sensing module contains an inertial sensor (IMU, Inertial Measurement Unit), which can mainly detect and measure acceleration, tilt, impact, vibration, rotation and multi-degree-of-freedom motion, and is an important component for solving navigation, orientation and motion carrier control. The inertial sensor includes an acceleration sensor, an angular velocity sensor and an inertial sensing module composed of a single, dual or three-axis combination thereof. The inertial sensing module used in this embodiment can be a three-axis acceleration sensor and a three-axis angular velocity sensor that are separately disposed, or a six-axis gyroscope that can simultaneously measure three-axis acceleration and three-axis angular velocity.

Optionally, the time interval for acquiring the motion data of the inertial sensing module can be set according to actual conditions, and the embodiment it not limited to it. For example, the acquisition time interval is short enough to basically achieve real-time acquisition, and then, real-time calculation of the current position and posture of the vehicle-mounted remote controller is realized.

In an embodiment, referring to FIG. 4, a vehicle-mounted remote controller position and posture recognition system includes: a vehicle, a vehicle-mounted remote controller and a control device, wherein the control device may be a local device disposed on the vehicle or the vehicle-mounted remote controller, or may be a remote device, etc., and the present disclosures is not limited to it; and then the control device dynamically acquires first motion data of the vehicle collected by a first inertial sensing module disposed on the vehicle, and second motion data of the vehicle-mounted remote controller collected by a second inertial sensing module disposed on the vehicle-mounted remote controller.

Step S30, correcting the second motion data based on the first motion data to obtain the current motion data of the vehicle-mounted remote controller.

During the driving, the vehicle may experience bumps and other situations. Therefore, when the user holds the vehicle-mounted remote controller and aims at the target vehicle device and keeps it remain unmoved, the vehicle-mounted remote controller may still move with the vehicle, resulting in certain interference information in the acquired second motion data of the vehicle-mounted remote controller; therefore, if the position and posture recognition of the vehicle-mounted remote controller is performed only based on the second motion data, the position and posture information obtained may have a large error and cause the target vehicle device to be recognized incorrectly. To improve the accuracy of the position and posture recognition of the vehicle-mounted remote controller, the second motion data of the vehicle-mounted remote controller is corrected based on the acquired first motion data of the vehicle to eliminate the interference information in the second motion data and accurately obtain the current motion data of the vehicle-mounted remote controller relative to the vehicle.

In an alternative embodiment, step S30 of correcting the second motion data based on the first motion data to obtain the current motion data of the vehicle-mounted remote controller includes:
Step S31, determining relative motion data of the vehicle-mounted remote controller relative to the vehicle according to a data difference between the first motion data and the second motion data, and determining the relative motion data as the current motion data.

Since there is relative motion between the vehicle-mounted remote controller and the vehicle, and the motion data of the relative motion represents the motion of the vehicle-mounted remote controller in the vehicle cabin, the motion data of the vehicle-mounted remote controller relative to the vehicle (hereinafter referred to as relative motion data for distinction) is determined according to the data difference between the first motion data and the second motion data, and the relative motion data is set as the current motion data of the vehicle-mounted remote controller, so as to correct the motion data collected by the second inertial sensing module, eliminate the influence of the vehicle on the motion data collected by the second inertial sensing module of the vehicle-mounted remote controller during driving, and improve the accuracy of subsequent position and posture recognition of the vehicle-mounted remote controller in the vehicle.

Step S40, determining the current position and posture of the vehicle-mounted remote controller according to the initial position and posture and the current motion data.

According to the acquired initial position and posture and the current motion data of the vehicle-mounted remote controller, the current position and posture of the vehicle-mounted remote controller is calculated, which may include the current position and the current posture.

In an embodiment, referring to FIG. 5, when the vehicle-mounted remote controller is in use, if a trigger operation for the intelligent remote control is detected, for example, a button on the vehicle-mounted remote controller is triggered, wherein the button may be a virtual button or a physical button, indicating that the user intended to interact with the vehicle device, the current orientation of the vehicle-mounted remote controller can be determined according to the current position and posture when the trigger operation for the smart remote control is detected, and then an directional ray L1 is generated in the direction of the current orientation with the current position Q1 in the current position and posture as the starting point; and then the target device is determined from the vehicle devices, namely, P1 and P2, of the vehicle through which the directional ray passes, wherein the vehicle device P1 that is closest to the vehicle device through which the directional ray passes can be determined as the target device, and the vehicle device within a preset range of distance among the vehicle devices through which the directional ray passes can also be determined as the target device, and the present disclosures is not limited to it.

In this embodiment, the accuracy of the position and posture recognition of the vehicle-mounted remote controller in the vehicle scenario is improved by: acquiring the initial position and posture of the vehicle-mounted remote controller, and dynamically acquiring the first motion data of the vehicle collected by the first inertial sensing module disposed on the vehicle, and the second motion data of the vehicle-mounted remote controller collected by the second inertial sensing module disposed on the vehicle-mounted remote controller; then correcting, based on the first motion data of the vehicle, the second motion data of the vehicle-mounted remote controller to eliminate the data error caused by the vehicle motion in the vehicle scene and obtain the accurate current motion data of the vehicle-mounted remote controller; and then accurately recognizing, based on the initial position and posture and the accurate current motion data, the current position and posture of the vehicle-mounted remote controller.

Further, based on the above-mentioned first embodiment, a second embodiment of the method of recognizing the position and posture of a vehicle-mounted remote controller of the present disclosure is proposed. In this embodiment, the vehicle is provided with at least one storage slot for fixing the vehicle-mounted remote controller and keeping the position and posture thereof unchanged in the vehicle. After the determining the current position and posture of the vehicle-mounted remote controller in step S40, the method further includes:

Step S50, determining whether the vehicle-mounted remote controller is in the storage slot of the vehicle.

At least one storage slot is provided in the vehicle for fixing the vehicle-mounted remote controller and keeping the position thereof unchanged in the vehicle; and then it is determined whether the vehicle-mounted remote controller is in any storage slot of the vehicle.

In an alternative embodiment, in step S50 of determining whether the vehicle-mounted remote controller is in the storage slot of the vehicle includes:
Step S51, determining whether the current position and posture matches a preset fixed position and posture, and whether a duration for which the current position and posture matches the fixed position and posture is greater than a preset duration, wherein the fixed position and posture is a position and posture of the vehicle-mounted remote controller when it is in the storage slot of the vehicle; and
Step S52: if it is, determining that the vehicle-mounted remote controller is in the storage slot of the vehicle.

It is determined whether the calculated current position and posture of the vehicle-mounted remote controller matches the fixed position and posture when the vehicle-mounted remote controller is placed in each storage slot; if it matches, further determine whether the duration for which the current position and posture matches the fixed position and posture is greater than a preset duration; and if is greater, the vehicle-mounted remote controller is in the storage slot of the vehicle, and the user is not using the vehicle-mounted remote controller temporarily.

In another alternative embodiment, at least one detecting sensor for detecting whether the vehicle-mounted remote controller is placed in the storage slot is provided in the storage slot, and step S50 of determining whether the vehicle-mounted remote controller is in the storage slot of the vehicle includes:
Step S53: in response to detecting that the detected signal collected by the detecting sensor matches a preset signal, determining that the vehicle-mounted remote controller is in the storage slot of the vehicle.

At least one detecting sensor for detecting whether the vehicle-mounted remote controller is placed in the storage slot of the vehicle is provided in the storage slot. By detecting the detected signal collected by the detecting sensor, it can be confirmed whether the vehicle-mounted remote controller is in the storage slot of the vehicle; and then when it is detected that the detected signal collected by the detecting sensor matches the preset signal, it is determined that the vehicle-mounted remote controller is in the storage slot of the vehicle, wherein the preset signal is a signal generated when the vehicle-mounted remote controller is in the storage slot and the position and posture of the vehicle-mounted remote controller matches the fixed position and posture corresponding to the storage slot. That is, if the vehicle-mounted remote controller is not placed according to the placement requirements of the storage slot, for example, it is not completely placed in the storage slot, then the current position and posture of the vehicle-mounted remote controller does not match the fixed position and posture corresponding to the storage slot, and then the detected signal collected by the detecting sensor does not match the preset signal.

Optionally, if other devices are placed in, the detected signal collected by the detecting sensor does not match the preset signal, to avoid erroneous determination of the status of the vehicle-mounted remote controller due to the placement of other devices in the storage slot.

Step S60: if it is, entering the vehicle-mounted remote controller into a sleep state, and stopping the dynamically acquiring the second motion data collected by the second inertial sensing module.

If the vehicle-mounted remote controller is in any storage slot of the vehicle, it indicates that the user is not using the vehicle-mounted remote controller temporarily, and because the position of the vehicle-mounted remote controller in the vehicle is fixed and will not change when the vehicle-mounted remote controller is in the storage slot of the vehicle, the vehicle-mounted remote controller may enter a sleep state and the dynamically acquiring the second motion data collected by the second inertial sensing module is stopped to reduce power consumption and calculation amount.

Optionally, based on the first motion data collected by the first inertial sensing module, it is determined whether the vehicle is in a driving state. if it is, the vehicle-mounted remote controller enters into a first sleep state; wherein, in the first sleep state, the functional modules on the vehicle-mounted remote controller except the second inertial sensing module can stop operation; since the vehicle-mounted remote controller has been placed in the storage slot, the user will not use the vehicle-mounted remote controller before taking out the vehicle-mounted remote controller; but since the vehicle is in the driving process, that is, there is already a user in the vehicle, it is still necessary to wake up the vehicle-mounted remote controller at any time, so the second inertial sensing module is kept running. If the vehicle is not in a driving state, indicating that the user has left the vehicle, the vehicle-mounted remote controller enters a second sleep state, wherein, in the second sleep state, all functional modules of the vehicle-mounted remote controller stop operation.

In this embodiment, it is determined whether the vehicle-mounted remote controller is in the storage slot of the vehicle; and if it is, the vehicle-mounted remote controller enters a sleep state and stops the dynamically acquiring the second motion data collected by the second inertial sensing module. After the vehicle-mounted remote controller is placed in the storage slot, the acquisition of the motion data of the vehicle-mounted remote controller and the calculation of the position and posture are stopped to reduce power consumption and calculation amount.

In an alternative embodiment, at least one detecting sensor for detecting whether the vehicle-mounted remote controller is placed in the storage slot is provided in the storage slot. After the entering the vehicle-mounted remote controller into the sleep state in step S60, the method further includes:
Step S61, dynamically acquiring the detected signal collected by the detecting sensor; and
Step S62, in response to detecting that the detected signal does not match the preset signal, awakening the vehicle-mounted remote controller from the sleep state, and resuming the dynamically acquiring the second motion data collected by the second inertial sensing module.

After the vehicle-mounted remote controller enters the sleep state, in order to ensure normal use by the user, the detected signal collected by the detecting sensor set at the storage slot is dynamically acquired to determine whether the vehicle-mounted remote controller has been taken out; and when it is detected that the detected signal does not match the preset signal, it indicates that the vehicle-mounted remote controller has been taken out, the vehicle-mounted remote controller is promptly awakened from the sleep state, and resuming the dynamically acquiring the second motion data collected by the second inertial sensing module to resuming the real-time calculation of the position and posture of the vehicle-mounted remote controller.

Furthermore, an embodiment of the present disclosure also provides a vehicle-mounted remote controller position and posture recognition system including a vehicle, a vehicle-mounted remote controller and a control device communicatively connected to one another, wherein the vehicle-mounted remote controller position and posture recognition system includes:
the vehicle having a first inertial sensing module disposed therein.

Optionally, the vehicle is further provided with at least one storage slot for fixing the vehicle-mounted remote controller and keeping the position and posture unchanged in the vehicle.

Optionally, at least one detecting sensor for detecting whether the vehicle-mounted remote controller is placed in the storage slot is provided in the storage slot.

The vehicle-mounted remote controller has a second inertial sensing module disposed therein.

The control device is configured to: acquire an initial position and posture of the vehicle-mounted remote controller; dynamically acquire first motion data collected by the first inertial sensing module, and dynamically acquire second motion data collected by the second inertial sensing module; correct the second motion data based on the first motion data to obtain the current motion data of the vehicle-mounted remote controller; and determine the current position and posture of the vehicle-mounted remote controller according to the initial position and posture and the current motion data.

Optionally, the control device is further configured to:
determine a target storage slot of the vehicle-mounted remote controller where it was last placed before being taken out, based on a detecting sensor provided in the storage slot; and
recognize a preset fixed position and posture of the vehicle-mounted remote controller when it is in the target storage slot, and determining the recognized preset fixed position and posture as the initial position and posture.

Optionally, the control device is further configured to:
determine relative motion data of the vehicle-mounted remote controller relative to the vehicle according to a data difference between the first motion data and the second motion data, and determining the relative motion data as the current motion data.

Optionally, the control device is further configured to:
determine whether the vehicle-mounted remote controller is in the storage slot of the vehicle; and
if it is, entering the vehicle-mounted remote controller into a sleep state, and stop the dynamically acquiring the second motion data collected by the second inertial sensing module.

Optionally, the control device is further configured to:
determine whether the current position and posture matches a preset fixed position and posture, and whether a duration for which the current position and posture matches the fixed position and posture is greater than a preset duration, wherein the fixed position and posture is a position and posture of the vehicle-mounted remote controller when it is in the storage slot of the vehicle; and
if it is, determine that the vehicle-mounted remote controller is in the storage slot of the vehicle.

Optionally, the control device is further configured to:
in response to detecting that the detected signal collected by the detecting sensor matches a preset signal, determine that the vehicle-mounted remote controller is in the storage slot of the vehicle.

Optionally, the control device is further configured to:
dynamically acquire the detected signal collected by the detecting sensor; and
in response to detecting that the detected signal does not match the preset signal, awakening the vehicle-mounted remote controller from the sleep state, and resuming the dynamically acquiring the second motion data collected by the second inertial sensing module.

The specific embodiment of the vehicle-mounted remote controller position and posture recognition system of the present disclosure is basically the same as the embodiments of the above-mentioned method of recognizing the position and posture of a vehicle-mounted remote controller, and will not be repeated here.

It will be noted that, in this article, the terms “include”, “comprise” or any other variations thereof are intended to cover non-exclusive inclusion, so that a process, method, article or system including a series of elements includes not only those elements, but also other elements not explicitly listed, or also includes elements inherent to such process, method, article or system. In the absence of further restrictions, an element defined by the sentence “comprises a . . . ” does not exclude the presence of other identical elements in the process, method, article or system including the element.

Through the description of the above embodiments of methods, those skilled in the art can clearly understand that the above-mentioned embodiments of methods can be implemented by means of software plus a necessary general hardware platform, and of course by hardware, but in many cases the former is a better embodiment. Based on such an understanding, the technical solution of the present disclosure is essentially or the part that contributes to the prior art can be embodied in the form of a software product, which is stored in a storage medium (such as ROM/RAM, magnetic disk, optical disk) as described above, and includes a number of instructions for a terminal device (which can be a mobile phone, computer, server, or remote device, etc.) to execute the methods described in each embodiment of the present disclosure.

The above are only preferred embodiments of the present disclosure, and are not intended to limit the patent scope of the present disclosure. Any equivalent structure or equivalent process transformation made using the contents of the present disclosure specification and drawings, or directly or indirectly applied in other related technical fields, are also included in the patent protection scope of the present disclosure.

1. A method of recognizing a position and posture of a vehicle-mounted remote controller, applied to a vehicle-mounted remote controller position and posture recognition system comprising a vehicle having a first inertial sensing module disposed therein and a vehicle-mounted remote controller having a second inertial sensing module disposed therein, comprising:
acquiring an initial position and posture of the vehicle-mounted remote controller;
dynamically acquiring first motion data collected by the first inertial sensing module, and dynamically acquiring second motion data collected by the second inertial sensing module;
correcting the second motion data based on the first motion data to obtain current motion data of the vehicle-mounted remote controller; and
determining a current position and posture of the vehicle-mounted remote controller according to the initial position and posture and the current motion data.

2. The method of recognizing the position and posture of the vehicle-mounted remote controller according to claim 1, wherein the vehicle is provided with at least one storage slot for fixing the vehicle-mounted remote controller and keeping a position and posture thereof unchanged in the vehicle, and wherein the acquiring the initial position and posture of the vehicle-mounted remote controller comprises:
determining a target storage slot of the vehicle-mounted remote controller where it was last placed before being taken out, based on a detecting sensor provided in the storage slot; and
recognizing a preset fixed position and posture of the vehicle-mounted remote controller when it is in the target storage slot, and determining the recognized preset fixed position and posture as the initial position and posture.

3. The method of recognizing the position and posture of the vehicle-mounted remote controller according to claim 1, wherein the correcting the second motion data based on the first motion data to obtain the current motion data of the vehicle-mounted remote controller comprises:
determining relative motion data of the vehicle-mounted remote controller relative to the vehicle according to a data difference between the first motion data and the second motion data, and determining the relative motion data as the current motion data.

4. The method of recognizing the position and posture of the vehicle-mounted remote controller according to claim 1, wherein the vehicle is provided with at least one storage slot for fixing the vehicle-mounted remote controller and keeping a position and posture thereof unchanged in the vehicle, and wherein after the determining the current position and posture of the vehicle-mounted remote controller, the method further comprises:
determining whether the vehicle-mounted remote controller is in the storage slot of the vehicle; and
if it is, entering the vehicle-mounted remote controller into a sleep state, and stopping the dynamically acquiring the second motion data collected by the second inertial sensing module.

5. The method of recognizing the position and posture of the vehicle-mounted remote controller according to claim 4, wherein the determining whether the vehicle-mounted remote controller is in the storage slot of the vehicle comprises:
determining whether the current position and posture matches a preset fixed position and posture, and whether a duration for which the current position and posture matches the fixed position and posture is greater than a preset duration, wherein the fixed position and posture is a position and posture of the vehicle-mounted remote controller when it is in the storage slot of the vehicle; and
if it is, determining that the vehicle-mounted remote controller is in the storage slot of the vehicle.

6. The method of recognizing the position and posture of the vehicle-mounted remote controller according to claim 4, wherein at least one detecting sensor for detecting whether the vehicle-mounted remote controller is placed in the storage slot is provided in the storage slot, and wherein the determining whether the vehicle-mounted remote controller is in the storage slot of the vehicle comprises:
in response to detecting that the detected signal collected by the detecting sensor matches a preset signal, determining that the vehicle-mounted remote controller is in the storage slot of the vehicle.

7. The method of recognizing the position and posture of the vehicle-mounted remote controller according to claim 4, wherein at least one detecting sensor for detecting whether the vehicle-mounted remote controller is placed in the storage slot is provided in the storage slot, and wherein after the entering the vehicle-mounted remote controller into the sleep state, the method further comprises:
dynamically acquiring detected signal collected by the detecting sensor; and
in response to detecting that the detected signal does not match a preset signal, awakening the vehicle-mounted remote controller from the sleep state, and resuming the dynamically acquiring the second motion data collected by the second inertial sensing module.

8. A vehicle-mounted remote controller position and posture recognition system comprising a vehicle, a vehicle-mounted remote controller and a control device communicatively connected to one another,
wherein the vehicle has a first inertial sensing module disposed therein,
wherein the vehicle-mounted remote controller has a second inertial sensing module disposed therein, and
wherein the control device is configured to: acquire an initial position and posture of the vehicle-mounted remote controller; dynamically acquire first motion data collected by the first inertial sensing module, and dynamically acquire second motion data collected by the second inertial sensing module; correct the second motion data based on the first motion data to obtain current motion data of the vehicle-mounted remote controller; and determine a current position and posture of the vehicle-mounted remote controller according to the initial position and posture and the current motion data.

9. A vehicle-mounted remote controller comprising a memory, a processor, and a vehicle-mounted remote controller position and posture recognition program stored in the memory and executable by the processor, wherein the vehicle-mounted remote controller position and posture recognition program is configured to implement steps of the method of recognizing the position and posture of the vehicle-mounted remote controller according to claim 1.

10. A non-transitory storage medium, wherein the storage medium is a computer-readable storage medium, and a vehicle-mounted remote controller position and posture recognition program is stored on the storage medium, wherein the vehicle-mounted remote controller position and posture recognition program is configured to implement, when executed by a processor, steps of the method of recognizing the position and posture of the vehicle-mounted remote controller according to claim 1.
